(19) United States
(12) Patent Application Publication
(10) Pub. No.: US 2019/0054759 A1
(43) Pub. Date: Feb. 21, 2019

(54) WATER TRAY ASSEMBLY WITH STORAGE FUNCTIONS

(71) Applicant: Shou-Te CHEN, Taichung City (TW)

(72) Inventor: Shou-Te CHEN, Taichung City (TW)

(21) Appl. No.: 15/677,026

(22) Filed: Aug. 15, 2017

(51) Int. Cl. B43M 99/00; A01G 9/04

(52) U.S. Cl. CPC B43M 99/001; A01G 9/04

(57) ABSTRACT

A water tray assembly with storage functions is suitable for use in combination with a plant pot and a stationery product, and includes: a water tray, a lateral wall and an annular catchment wall, a catchment basin defined by the bottom surface and the annular catchment wall, and a storage space, wherein the storage space includes an opening, and a positioning protrusion protrudes from the catchment basin. A storage tray is mounted on the water tray to seal the opening, and includes a catchment hole in communication with the catchment basin. The storage tray includes holding apertures in communication with the storage space, the plant pot is inserted through the catchment hole and placed on the annular catchment wall, the positioning protrusion is pressed against the plant pot, and the stationery product is inserted through the holding apertures into the storage space.

### BACKGROUND OF THE INVENTION

### Field of the Invention

The present invention relates to a water tray, and more particularly to a water tray assembly with storage functions.

### Related Prior Art

People usually would like to put some plant pots on the table at home, or in office or meeting room in order to add some green to the environment, which makes people feel released.

Under each of the plant pots is usually placed a water tray, so that, when the user is watering the plant pot, water will flow through the plant pot into the water tray without wetting the table where the plant pot is placed.

However, the water tray beneath the plant pot is only capable of carrying the water from the plant pot, and the plant pot also only has the ornamental function. The water tray and the plant pot occupy a part of the table, but have no other practical functions.

The present invention has arisen to mitigate and/or obviate the afore-described disadvantages.

### SUMMARY

One objective of the present invention is to enable the water tray of the plant pot put on the table at home, in office or meeting room to have the storage function, which improves the practicality of the water tray and plant pot.

To achieve the above objective, a water tray assembly with storage functions in accordance with the present invention is suitable for use in combination with a plant pot and a stationery product, and comprises:

a water tray including a bottom surface, a lateral wall extending upward from a peripheral edge of the bottom surface, an annular catchment wall protruding upward from the bottom surface, a catchment basin defined by the bottom surface and the annular catchment wall, and a storage space defined by the annular catchment wall, the bottom surface and the lateral wall, wherein the storage space includes an opening, and a positioning protrusion protrudes upward from the bottom surface within the catchment basin; and

a storage tray mounted on the water tray to seal the opening, and including a catchment hole in communication with the catchment basin, wherein the storage tray is provided with a plurality of holding apertures in communication with the storage space, the plant pot is inserted through the catchment hole and placed on the annular catchment wall, the positioning protrusion is pressed against the plant pot to make the plant pot stable, and the stationery product is inserted through the holding apertures into the storage space.

Preferably, the bottom surface is round-shaped, the positioning protrusion protrudes upward from a center of the bottom surface, and the annular catchment wall surrounds the center of the bottom surface.

Preferably, the water tray assembly with storage functions further comprises three storage boxes, each of the storage boxes includes a peripheral frame and a recess, there are three said holding apertures, the storage tray is provided with a mounting surface beside each of the holding apertures, the storage boxes are inserted through the holding apertures into the storage space, and have their respective peripheral frames placed on the mounting surfaces, so that the storage boxes are fixed to the holding apertures.

Preferably, the plant pot is provided at a bottom thereof with a drain hole for insertion and fixing of the positioning protrusion, and the positioning protrusion is hollow structure with an inner passage in communication with the catchment basin.

Preferably, the water tray assembly with storage functions further comprises a plant insertion tube which is a hollow tube with two open ends, a bottom of the plant pot is provided with a plant insertion hole, the plant insertion tube is inserted through the plant insertion hole and has one end inserted in the catchment basin and another end inserted in the plant pot, and the plant insertion tube is provided for insertion of a plant.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an exploded view of a water tray assembly with storage functions in accordance with a preferred embodiment of the present invention;

FIG. 2 is an assembly view of the water tray assembly with storage functions in accordance with the preferred embodiment of the present invention;

FIG. 3 is a cross sectional view of the water tray assembly with storage functions in accordance with the preferred embodiment of the present invention; and

FIG. 4 is a cross sectional view of the water tray assembly with storage functions in accordance with another preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

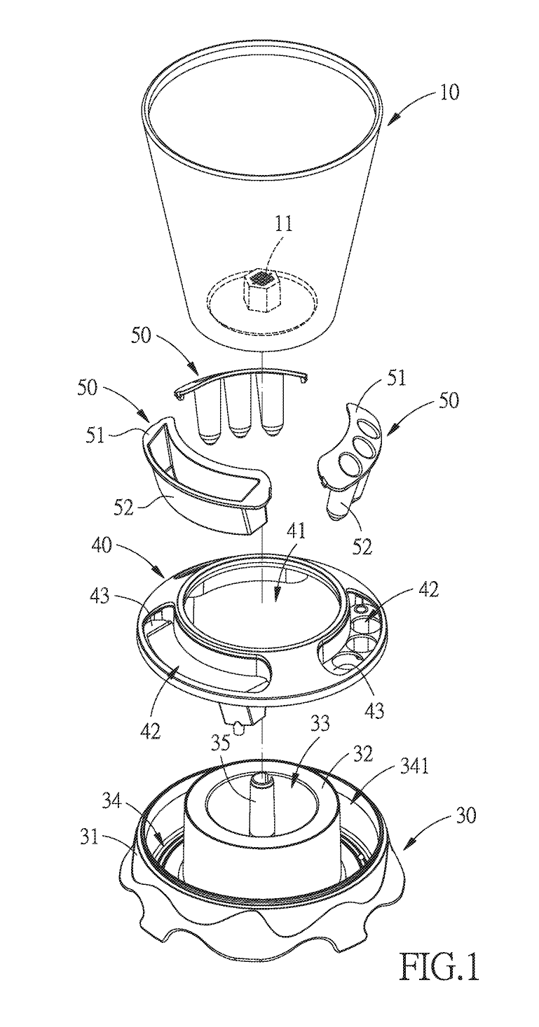

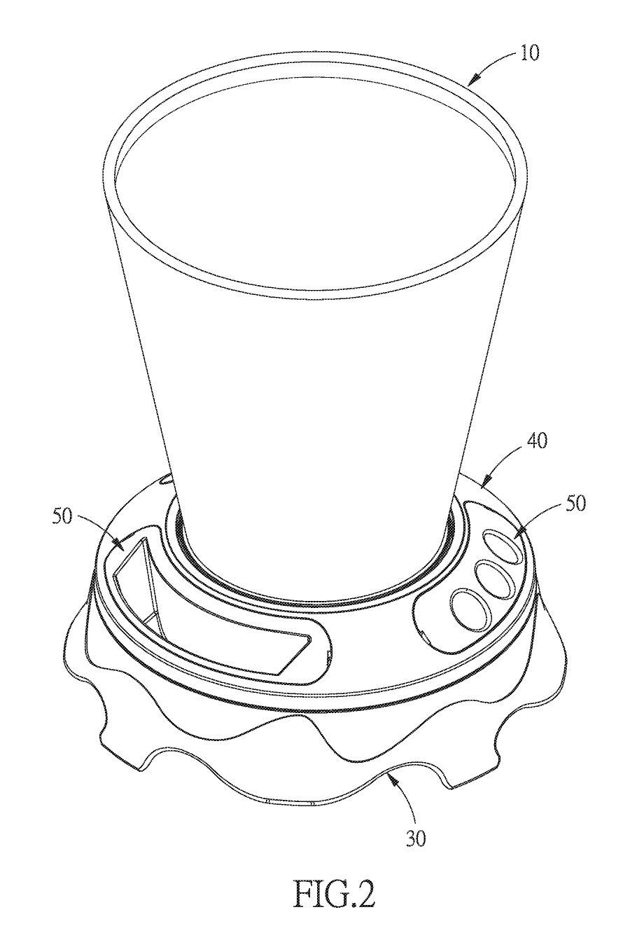

Referring to FIGS. 1-3, a water tray assembly with storage functions in accordance with the present invention is suitable for use in combination with a plant pot 10 and a stationery product 20, and comprises: a water tray 30 and a storage tray 40.

The water tray 30 includes a bottom surface 301, a lateral wall 31 extending upward from a peripheral edge of the bottom surface 301, an annular catchment wall 32 protruding upward from the bottom surface 301, a catchment basin 33 defined by the bottom surface 301 and the annular catchment wall 32, and a storage space 34 defined by the annular catchment wall 32, the bottom surface 301 and the lateral wall 31. The storage space 34 includes an opening 341 in communication with the storage space 34, and a positioning protrusion 35 protrudes upward from the bottom surface 301 and is located inside the catchment basin 33.

In this embodiment, the bottom surface 301 is approximately round-shaped, the positioning protrusion 35 protrudes upward from the center of the bottom surface 301, and the annular catchment wall 32 surrounds the center of the bottom surface 301.

The storage tray 40 is mounted on the water tray 30 to seal the opening 341, and includes a catchment hole 41 in communication with the catchment basin 33. The storage tray 40 is provided with a plurality of holding apertures 42 in communication with the storage space 34. The plant pot 10 is inserted through the catchment hole 41 and placed on a top surface of the annular catchment wall 32, in such a manner that the positioning protrusion 35 is pressed against the plant pot 10, so that the plant pot 10 is stable, and the stationery product 20 is inserted through the holding apertures 42 into the storage space 34.

In this embodiment, the storage tray 40 is circular shaped, and the holding apertures 42 are located at the center of the storage tray 40 and aligned to the catchment basin 33 and the annular catchment wall 32.

The water tray with storage functions in accordance with the present invention further includes three storage boxes 50, each of which includes a peripheral frame 51 and a recess 52. The storage box 50, when used for holding pens, is provided with three recesses 52, and each of the recesses 52 is shaped to conform to the shape of pens. When used for holding the stationery product 20, the storage box 50 is provided with one recess 52. The storage tray 40 is provided with a mounting surface 43 beside each of the holding apertures 42, so that the storage boxes 50, when inserted through the holding apertures 42 into the storage space 34, can have their peripheral frames 51 placed on the mounting surfaces 43 to fix the storage boxes 50 to the holding apertures 42.

In this embodiment, the plant pot 10 is provided at a bottom thereof with a drain hole 11 for insertion of the positioning protrusion 35. The positioning protrusion 35 is hollow structure with an inner passage 351 in communication with the catchment basin 33.

In another embodiment, the bottom of the plant pot 10 is provided with a plant insertion hole 12. The water tray with storage functions of the invention further includes a plant insertion tube 60 which is a hollow tube with two open ends. The plant insertion tube 60 is inserted through the plant insertion hole 12 with one end inserted in the catchment basin 33 and another end inserted in the plant pot 10. A plant A (flower) can be inserted in the plant insertion tube 60 and can be replaced at any time.

What mentioned above are the structural relations of the main components of the invention, and the use of the invention is explained below.

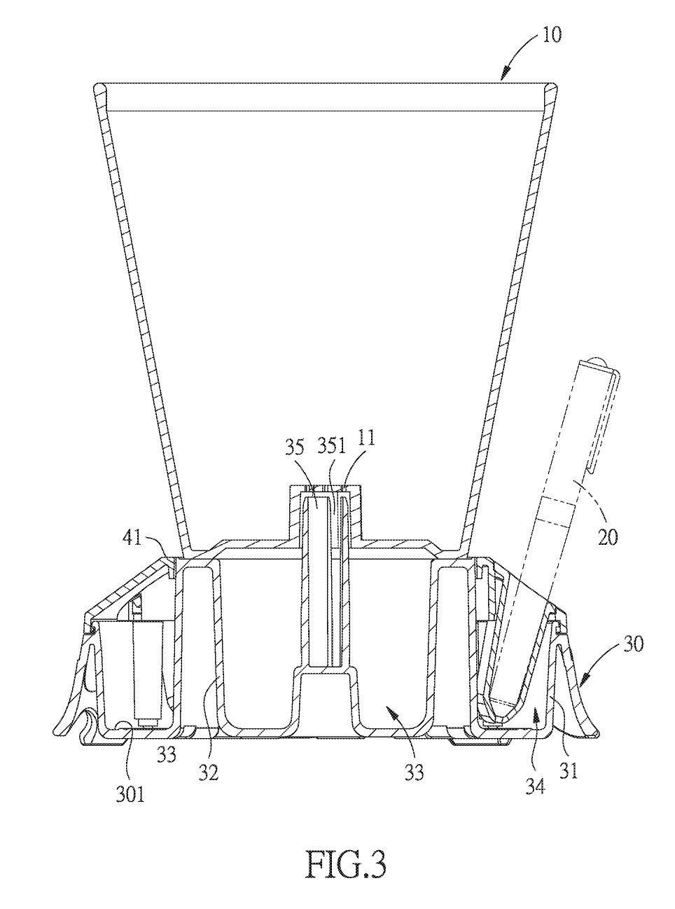

As shown in FIG. 3, when the user wants to insert a pen or a stationery product 20 in the storage box 50, she/he can insert it in the recess 52.

If the user is watering the plant in the plant pot 10, excessive water can flow into the positioning protrusion 35 via the drain hole 11, and finally flow through the positioning protrusion 35 into the catchment basin 33.

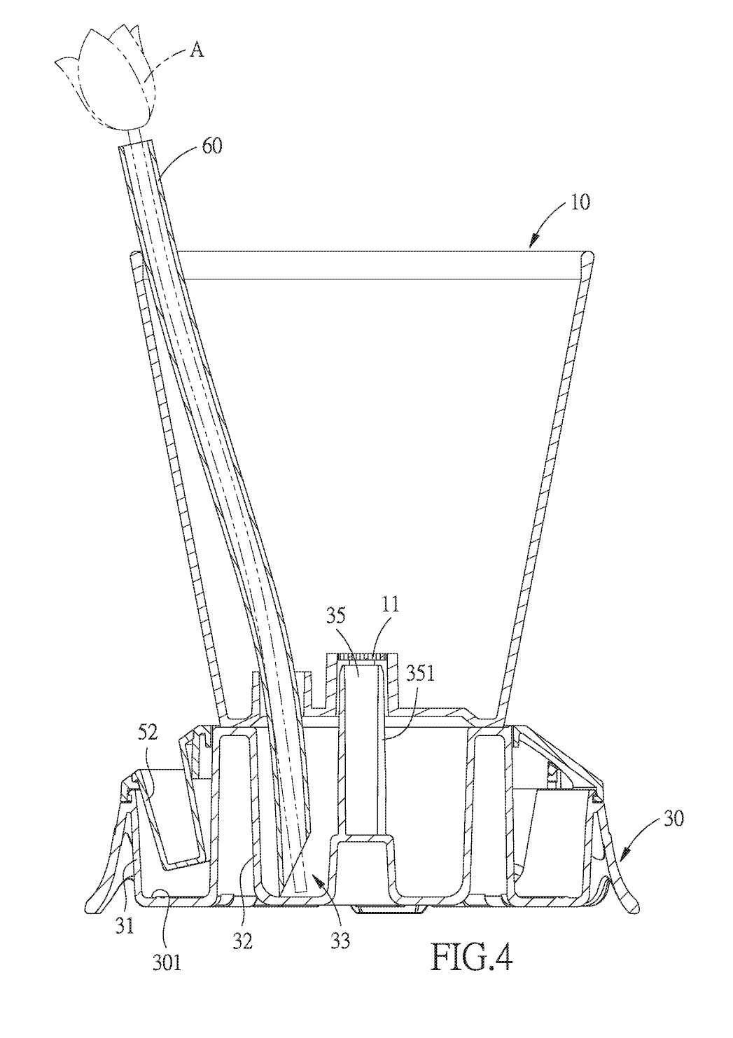

FIG. 4 shows another embodiment, wherein the plant A can be inserted in the plant insertion tube 60, so that, when placed on the table at home, in office or meeting room, the water tray assembly with storage functions in accordance with the present invention is not only capable of beautifying the environment, but also can hold the stationery product 20, which enhances the overall practicality.

While we have shown and described various embodiments in accordance with the present invention, it is clear to those skilled in the art that further embodiments may be made without departing from the scope of the present invention.

What is claimed is:

1. A water tray assembly with storage functions suitable for use in combination with a plant pot and a stationery product, and comprising:
a water tray including a bottom surface, a lateral wall extending upward from a peripheral edge of the bottom surface, an annular catchment wall protruding upward from the bottom surface, a catchment basin defined by the bottom surface and the annular catchment wall, and a storage space defined by the annular catchment wall, the bottom surface and the lateral wall, wherein the storage space includes an opening, and a positioning protrusion protrudes upward from the bottom surface within the catchment basin; and
a storage tray mounted on the water tray to seal the opening, and including a catchment hole in communication with the catchment basin, wherein the storage tray is provided with a plurality of holding apertures in communication with the storage space, the plant pot is inserted through the catchment hole and placed on the annular catchment wall, the positioning protrusion is pressed against the plant pot to make the plant pot stable, and the stationery product is inserted through the holding apertures into the storage space.

2. The water tray assembly with storage functions as claimed in claim 1, wherein the bottom surface is round-shaped, the positioning protrusion protrudes upward from a center of the bottom surface, and the annular catchment wall surrounds the center of the bottom surface.

3. The water tray assembly with storage functions as claimed in claim 1 further comprising three storage boxes, each of the storage boxes includes a peripheral frame and a recess, there are three said holding apertures, the storage tray is provided with a mounting surface beside each of the holding apertures, the storage boxes are inserted through the holding apertures into the storage space, and have their respective peripheral frames placed on the mounting surfaces, so that the storage boxes are fixed to the holding apertures.

4. The water tray assembly with storage functions as claimed in claim 1, wherein the plant pot is provided at a bottom thereof with a drain hole for insertion and fixing of the positioning protrusion, and the positioning protrusion is hollow structure with an inner passage in communication with the catchment basin.

5. The water tray assembly with storage functions as claimed in claim 1 further comprising a plant insertion tube which is a hollow tube with two open ends, a bottom of the plant pot is provided with a plant insertion hole, the plant insertion tube is inserted through the plant insertion hole and has one end inserted in the catchment basin and another end inserted in the plant pot, and the plant insertion tube is provided for insertion of a plant.
